(19) United States
(12) Patent Application Publication
(10) Pub. No.: US 2025/0293584 A1
(43) Pub. Date: Sep. 18, 2025

(54) Two-Transistor Flyback Topology With Rompower High Efficiency Passive Clamp

(71) Applicant: Rompower Technology Holdings, LLC, Milford, DE (US)

(72) Inventors: Ionel Jitaru, Tucson, AZ (US); Andrei Stefan Savu, Bucuresti (RO)

(73) Assignee: Rompower Technology Holdings, LLC, Milford, DE (US)

(21) Appl. No.: 19/221,463

(22) Filed: May 28, 2025

Related U.S. Application Data
(63) Continuation-in-part of application No. 18/743,055, filed on Jun. 13, 2024.
Application No. 18/743,055 is a continuation-in-part of application No. 18/233,315, filed on Aug. 12, 2023, now abandoned.
Application No. 18/233,315 is a continuation of application No. 17/495,245, filed on Oct. 6, 2021, now Pat. No. 11,728,723.
Application No. 17/495,245 is a continuation-in-part of application No. 18/199,959, filed on May 21, 2023.
Application No. 18/199,959 is a continuation-in-part of application No. 17/495,170, filed on Oct. 6, 2021, now Pat. No. 11,671,027.
Application No. 17/495,170 is a continuation of application No. 16/751,747, filed on Jan. 24, 2020, now Pat. No. 11,165,360.
Application No. 16/751,747 is a continuation of application No. 16/503,432, filed on Jul. 3, 2019, now Pat. No. 10,574,148.
(60) Provisional application No. 63/508,252, filed on Jun. 14, 2023.
(60) Provisional application No. 63/508,254, filed on Jun. 14, 2023.
(60) Provisional application No. 63/652,578, filed on May 28, 2024.

(51) Int. Cl. H02M 1/08; H01F 38/42; H02M 1/00; H02M 1/34; H02M 1/42; H02M 3/155; H02M 3/335

(52) U.S. Cl. CPC H02M 1/083; H02M 1/4258; H02M 3/155; H02M 3/335; H02M 3/33553; H02M 3/33592; H01F 38/42; H02M 1/0058; H02M 1/342; Y02B 70/10

(57) ABSTRACT

A two-transistor flyback topology in which a portion of leakage inductance energy in the transformer is extracted and used to obtain zero voltage switching on both switching elements in any operating conditions, and in which a third low power switch eliminates parasitic oscillations and allows an operation at a determined frequency. In this topology, there are no switching losses and there are no spikes or glitches in any switching node, eliminating the need for snubbers. This topology is an “ideal two transistor flyback topology.”

### CROSS-REFERENCE TO RELATED APPLICATIONS

This application is a continuation-in-part of and claims the benefit of prior U.S. Patent Application No. 18/743,055, filed Jun. 13, 2024, is a continuation-in-part of and claims the benefit of prior U.S. Patent Application No. 18/199,959, filed May 21, 2023, and claims the benefit of U.S. Provisional Application No. 63/652,578, filed May 28, 2024, all of which are hereby incorporated by reference in their entireties.

### FIELD

The present specification relates generally to electricity, more particularly to topologies for power converters.

### BACKGROUND

Conventional flyback topology is the most popular topology in power conversion due to its simplicity, low cost and ability to work over a large input and output voltage range.

Conventional flyback topology has some limitations when used for offline applications and high voltage output like PD 3.1 EPR like 48V. The main problem faced is this topology is high voltage stress on the main primary switch due to a high voltage reflected from the secondary, wherein the voltage across the main switch is Vin+n*Vo, wherein Vin is the input voltage, “n” is the turns ratio in between the number of turns in the primary winding and the secondary winding, and Vo is the output voltage. The typical primary side switch is in the 650V-700V maximum voltage range. For a 48V output voltage application the reflected voltage plus input voltage can easily exceed 700V. The typical required transistor derating of 85% cannot be met in this case. The synchronous rectifier, (“SR”) has the same maximum voltage stress problem. The SR used in these types of applications have a maximum voltage of 120V in order to keep a low “on resistance” and low gate charge. In this topology the voltage applied on secondary synchronous rectifier is the input voltage divided by transformer turns ratio “n” plus output voltage which can easily exceed 130V. In order to meet the transistor voltage derating of minimum 85% the designer is forced to use 150V SR which is high cost, high gate charge and high “on resistance.” Trying to address the primary transistor voltage stress by adjusting the turns ratio increases the SR voltage stress and it is the same in the other way, addressing the SR voltage stress by changing the turns ratio affects the primary transistor voltage stress. As a result, changing the transformer turns ratio cannot fix the problem.

The use of two transistor flyback topology can reduce the voltage stress on the primary switchers. A two-transistor flyback topology is presented in FIG. 1. It includes a transformer Tr (600) having a primary winding L1 (250) and a secondary winding L2 (260), two switching devices, M1 (160) and M2 (180) and two clamp diodes, Dc1 (220) and Dc2 (210). In the secondary there is a synchronous rectifier SR (300) controlled by a control signal Vc(SR) (280). The primary switchers M1 and M2are controlled by two controlled signals Vc(M1) (240) and Vc(M2) (230). The two-transistor flyback is powered by the input voltage Vin (200). There is a primary ground (530) and a secondary ground (540).

FIG. 2 presents waveforms of the conventional two-transistor flyback topology. FIG. 2 depicts the control signals for M1 and M2 (330), the current through M1 and M2 (340), and the control signal which controls the SR (560). The waveforms which make this topology less attractive are the voltage across M1 and M2, Vds(M1&M2). At t0, when the switching elements M1 and M2 turn off, the energy in the leakage inductance flows into the Vin via Dc1 (220) and Dc2 (210). As a result, the voltage across M1 and M2 reaches Vin level. After all the energy in leakage inductance is delivered to Vin, at t1 from FIG. 2, a parasitic oscillation (360) does occur across the switching devices. This leads to a high noise which may disturb the operation of the controller IC in the primary and also the controller IC for the synchronous rectifier. At t2, the synchronous rectifier is turned off after all the energy accumulated in the magnetizing current of Tr1 (600) is transferred to the secondary via SR (300). This phenomenon which occurs after t1 becomes stronger when the difference from Vin to (Vin+nVo)/2, (380) becomes greater such is at lower Vo which in PD 3.1 is as low as 5V, and it is less relevant for high output voltage such as 48V. This is one of the drawbacks of the two-transistor flyback in application wherein output voltage has to operate in a large range as is PD3.1 specification, or in PD 3.0 when wherein the output voltage varies in between 3.3V to 20V. The second drawback associated with the conventional two transistor flyback topology is the operation in hard switching mode. The hard switching mode of operation creates switching losses at the time when the switching elements M1 and M2 turn on. FIG. 2 depicts Id(M1&M2), which represents the current through the switching elements M1 and M2. There is a spike of current through M1 and M2 at turn on (t3). The spike of current represents the discharge of the parasitic capacitance across M1 and M2 when M1 and M2 turn on. The hard switching mode of operation also creates a spike across SR at the time when M1 and M2 turn on.

In conclusion, in conventional two transistor flyback topology there are the following drawbacks: hard switching at turn on for both switching elements which leads to switching losses, and also leads to a voltage spike across the SR, (300) in the secondary. In addition to that the leakage inductance in the transformer is partially recycled between t0 to t1 from FIG. 2 and at t1 there is a parasitic oscillation, 360, which is energized by the voltage difference in between Vin and voltage level (Vin+nVo)/2, (380). That dissipates a portion of the leakage inductance energy and also injects high frequency noise in the converter which can disturb its operation, as previously mentioned.

### SUMMARY

In an embodiment, this disclosure describes a circuit with primary and secondary sides, where the circuit includes a flyback power converter having an input voltage source and a transformer with windings on the primary and secondary sides. Two main switchers are connected in series with the primary winding on the primary side, and each switcher is controlled by a distinct control signal. The first main switch is located between the input voltage source and the first terminal of the primary winding. The second main switch is connected to the second terminal of the primary winding. Parasitic capacitors are present across each of the two main switchers. A passive clamp circuit is placed across one of the switchers and includes a clamp diode and a clamp capacitor. An auxiliary circuit is also included, with first and second rectifiers connected in series with each other and with an electronic component that stores electromagnetic energy, where the anode of the first rectifier connects to the passive clamp and the cathode connects to the second terminal of the energy storage component, and the cathode of the second rectifier connects to the anode of the first rectifier while its anode connects to the first terminal of the energy storage component.

In embodiments, the auxiliary circuit reduces the RMS current and the charge through the clamp capacitor to levels that are at least twenty percent lower than their initial values. The clamp diode can be formed by several diodes arranged in parallel. The energy storage component can include a voltage source, where the second terminal is the positive terminal and the first terminal is the negative terminal. The clamp diode may alternatively be a control switch. The control switch can be a controlled MOSFET, with its body diode conducting in the same direction as the clamp diode. This control switch may be operated using a winding located in the transformer. The circuit may also include a driving transformer that controls at least one of the main switchers. The control switch may be actuated by one of the windings in this driving transformer.

In an embodiment, a method of operating this circuit includes providing a flyback power converter with an input voltage source and transformer having windings on primary and secondary sides, and placing two main switchers in series with the primary winding under control of two signals. A passive clamp circuit is added across one of the switchers and includes a clamp diode and capacitor. The auxiliary circuit with two rectifiers and an energy storage component is configured as previously described. A current flowing through leakage inductance reflected on the primary side is directed through the clamp capacitor and first rectifier into the energy storage component, so that a second charge value flows through the second rectifier during the reverse recovery time of the clamp diode and balances the electrical charge in the clamp capacitor.

In an embodiment, a method of operation uses an active clamp with a controlled switch clamp and a clamp capacitor, while the auxiliary circuit and current flow path are similar to those previously described. In this case, the current flows through the controlled switch clamp, the clamp capacitor, and the first rectifier into the energy storage component, and a second charge value flows through the second rectifier during the time that the controlled switch is conducting to balance the clamp capacitor.

In embodiments, a current injection circuit includes a current injection winding within the transformer, a current injection switch connected to one end of the winding, and a diode whose cathode connects to the opposite end of the winding and whose anode connects to the energy storage component. An energy source collects energy from the transformer's leakage inductance via the passive clamp and the first rectifier. The current injection winding delivers this energy as a pulse into the transformer to discharge parasitic capacitors across the two main switchers and establish a zero voltage switching condition. An embodiment collects leakage energy using the active clamp and injects it as a pulse current into the transformer to discharge the parasitic capacitors and achieve zero voltage switching. In embodiments, a third switch is between the first terminal of the primary winding and the terminal of the second main switch that is not connected to the winding. This third switch may be controlled by a signal that is complementary to the signal controlling the second main switch so that the third switch turns on when the second main switch is off. Alternatively, the third switch may be controlled by a signal that turns on for a set time after a small dead time following deactivation of the second switch. The control signal for the third switch may be timed to maintain a constant switching repetition frequency.

The above provides the reader with a very brief summary of some embodiments described below. Simplifications and omissions are made, and the summary is not intended to limit or define in any way the disclosure. Rather, this brief summary merely introduces the reader to some aspects of some embodiments in preparation for the detailed description that follows.

### BRIEF DESCRIPTION OF THE DRAWINGS

Referring to the drawings:

FIG. 1 is a schematic of a prior art power converter.

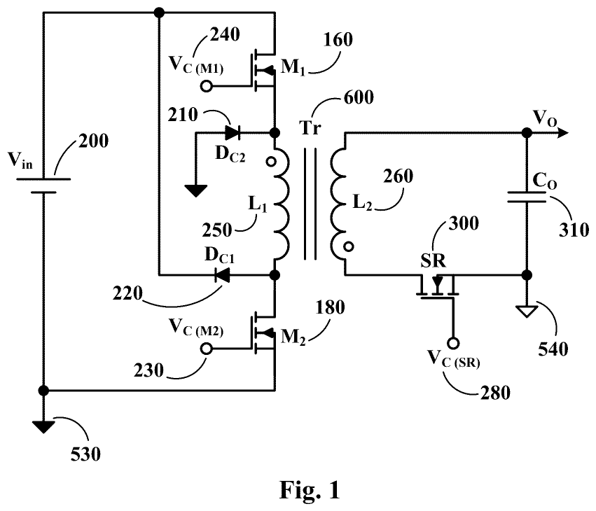

FIG. 2 illustrates waveforms of the power converter of FIG. 1.

FIG. 3A is a schematic of a two-transistor flyback converter according to an embodiment.

FIG. 3B is a schematic of the two-transistor flyback converter according to another embodiment.

FIG. 4 is an implementation of the voltage source presented in FIG. 3A.

FIG. 5 illustrates waveforms of the circuit depicted in FIG. 3A and FIG. 3B.

FIG. 6 presents a magnetic circuit suitable for use with the topology presented in FIG. 3A and FIG. 3B.

FIG. 7 presents a second magnetic circuit suitable for use with the topology presented in FIG. 3A and FIG. 3B.

FIG. 8 presents a third magnetic circuit suitable for use with the topology presented in FIG. 3A and FIG. 3B.

FIG. 9 illustrates waveforms of the circuit depicted in FIG. 3A and FIG. 3B.

FIG. 10 is a schematic of the two-transistor flyback converter according to another embodiment.

FIG. 11 illustrates waveforms of the circuit depicted in FIG. 10.

FIG. 12 presents different implementations of the clamp switch from FIG. 10.

FIG. 13 is a schematic of a two-transistor flyback converter according to another embodiment.

### DETAILED DESCRIPTION

Reference now is made to the drawings, in which the same reference characters are used throughout the different figures to designate the same elements. Briefly, the embodiments presented herein are preferred exemplary embodiments and are not intended to limit the scope, applicability, or configuration of all possible embodiments, but rather to provide an enabling description for all possible embodiments within the scope and spirit of the specification. Description of these preferred embodiments is generally made with the use of verbs such as “is” and “are” rather than “may,” “could,” “includes,” “comprises,” and the like, because the description is made with reference to the drawings presented. One having ordinary skill in the art will understand that changes may be made in the structure, arrangement, number, and function of elements and features without departing from the scope and spirit of the specification. Further, the description may omit certain information which is readily known to one having ordinary skill in the art to prevent crowding the description with detail which is not necessary for enablement. Indeed, the diction used herein is meant to be readable and informational rather than to delineate and limit the specification; therefore, the scope and spirit of the specification should not be limited by the following description and its language choices.

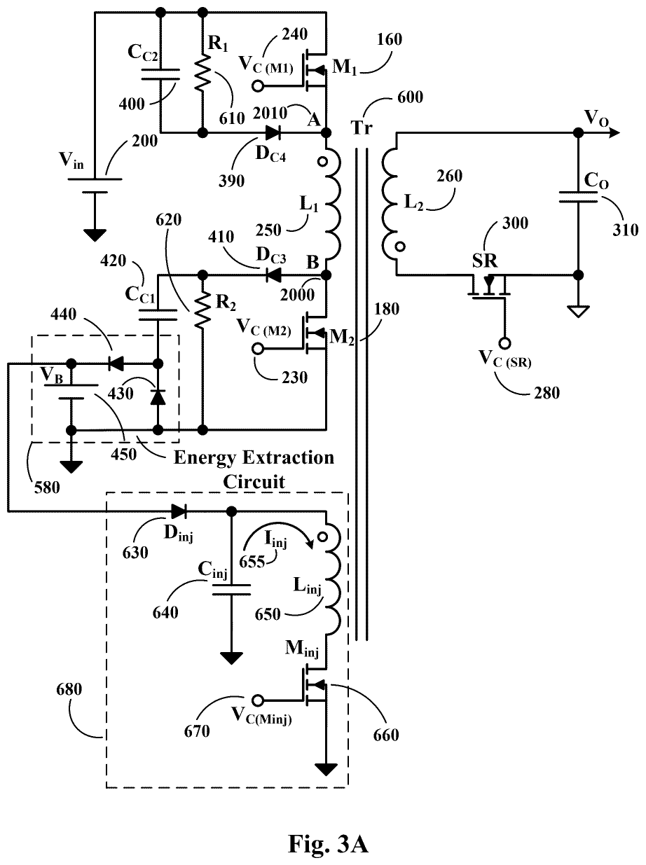

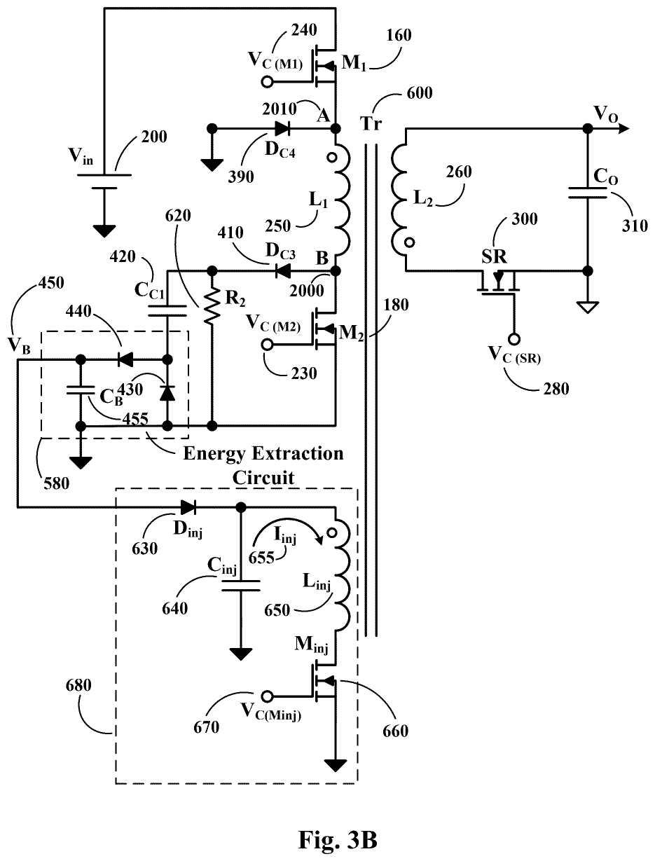

FIG. 3A depicts the two-transistor flyback topology using a high efficiency passive clamp method. Two passive clamp cells are used, one across M1, formed by diode Dc4 (390) and a clamp capacitor Cc2 (400). The second passive clamp cell is placed around M2, passive clamp formed by Dc3 (410) and Cc1 (420). The second clamp circuit is placed in series with an “Energy extraction circuit” (580). The Energy extraction circuit extracts some of the energy from the leakage inductance of the transformer and injects that energy into the voltage source, VB(450) from FIG. 3A. Without the Energy extraction circuit, the RMS current through the clamp has a larger value and there will be an additional ringing caused by the resonant circuit formed by the leakage inductance between primary and secondary winding of Tr (600) and the clamp capacitor Cc1, (420). In addition to that, the presence of the voltage source VB(450) also reduces the charge injected in Cc1, (420) and as a result reduces the reverse charge via Dc3, reverse charge which occurs during the reverse recovery of Dc3.

The use of the two passive clamp cells allows energy in the leakage inductance between L1 (250) and L2 (260) to split in between both passive clamp cells. Additionally, there are two resistors, R1 (610) and R2 (620), which create a small discharge of the CC1 and CC2 and initialize a small current flow through DC4 and DC3. The values of these resistors are in several hundred KOhm.

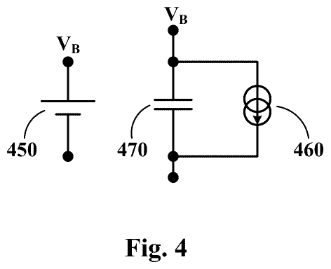

The VB, from the circuit (580) can be connected to the bias supply or, as in FIG. 4, can be formed by a capacitor (470) in parallel with a current source (460), which extracts energy from the capacitor 470 and uses that energy for a given purpose. In FIG. 3B, the voltage source VB, 450, is replaced by a capacitor CB, 455 which energizes the current injection circuit 680. The energy for the current injection is extracted from CB (455). The capacitor CB (455) is discharged by the current injection circuit (680). The voltage across CB (455) is labeled VB (450) the same as the voltage source from FIG. 3A. The current injection circuit creates a pulse of current which reflects into the primary winding of the transformer Tr1, 600, current which discharges the parasitic capacitance reflected across M1 (160) and M2 (180) creating zero voltage switching conditions for both switchers M1 and M2. Some of the energy from the leakage inductance between primary winding, L1 and secondary L2, supplies the energy to power the current injection circuit, (680) and creates zero voltage switching condition for M1 and M2. In FIG. 3B only one passive clamp (CC1 and DC3) is used, the first clamp is reduced to DC4 wherein we are relying on the reverse recovery of DC4 to allow the negative current flow, negative current which flows during the reverse recovery of DC3.

The reverse recovery characteristics of DC4, 390 and DC3, 410 are depicted in FIG. 3A and FIG. 3B. The reverse recovery characteristics of the DC4 and DC3 enable the reverse conduction to extract the charge injected in CC1 and CC2 after M1 and M2 turn off. The presence of VB, 450 decreases the forward charge injected in CC4 and CC3 and, as a result, also decreases the reverse charge in compliance with the preservation of charge law.

A first embodiment of this specification uses one or two passive clamps, placed across one or both of the main switching devices, M1 and M2 in order to extract a portion of the energy of the leakage inductance in between L1 and L2 of the transformer Tr(600) and inject said portion of leakage inductance energy in the VB, (450) as depicted in FIG. 3A or in CB, (455) as depicted in FIG. 3B. The energy injected in VB, (450) or CB, (455) is further used in energizing the current injection circuit, said current injection discharges the parasitic capacitances across M1 and M2 creating zero voltage switching conditions. The remaining leakage inductance energy after is partially injected in VB or CB is reflected: into the secondary winding L2 (260) of the transformer, Tr, (600) as a source of additional energy for the output load.

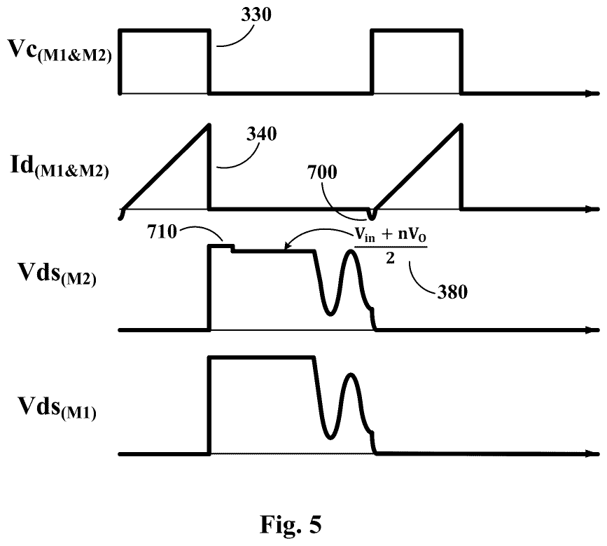

FIG. 5 depicts waveforms for the circuit depicted in FIG. 3A and FIG. 3B. The waveforms depicted in FIG. 5 are control voltage for M1 and M2, Vc(M1&M2), (330), the current through M1 and M2, (340), the voltage across M1, Vds(M1) and M2, Vds(M2). When current injection circuit is implemented, as depicted in FIG. 3A and 3B, the current through M1 and M2 has a small negative component, (700), wherein the current injection discharges the parasitic capacitance reflected across M1 and M2.

Thus, the passive clamp circuit (DC3 & CC1) placed across the switching element M2, together with the passive clamp (Dc4 & Cc2) placed across M1, or just Dc4 as depicted in FIG. 3B, together with VB (450), in FIG. 3A or CB (455), in FIG. 3B extracts a portion of the leakage inductance in between L1 and L2 of the transformer Tr1 and uses that energy to energize the current injection circuit, 680, and obtain zero voltage switching conditions across M1 and M2, The remaining leakage inductance energy is transferred to the secondary to further energize the output load of the flyback converter.

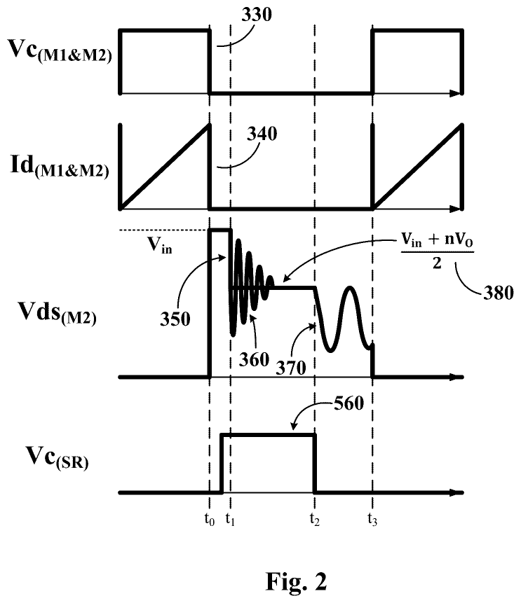

The circuit depicted in FIGS. 3A and 3B eliminates all the drawbacks of conventional two-transistor flyback converters creating zero voltage switching conditions on M1 and M2, and, as a result, eliminates the switching losses and also eliminates the spike across the secondary synchronous rectifier SR, (300) and eliminates the parasitic oscillation 360 across M2, as depicted in FIG. 2.

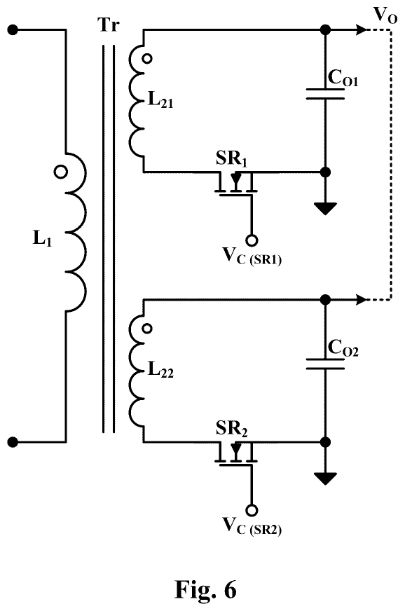

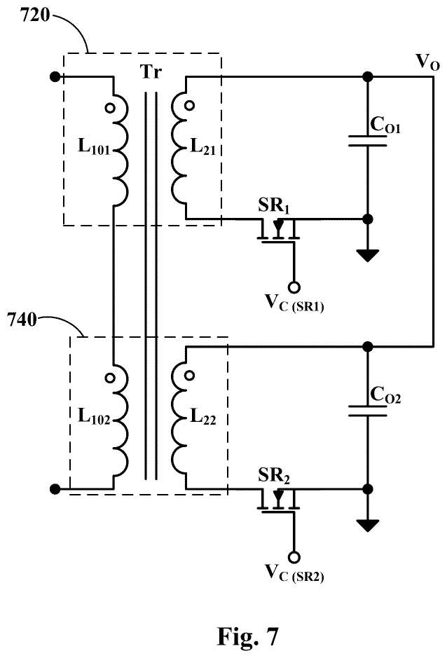

FIG. 6 depicts a transformer having one primary winding L1 and two secondary windings L21 and L22, each one having a synchronized rectifier SR1 and SR2. The output current provided towards Vo is shared by these two output windings. For a good coupling between primary and secondary, the primary winding is interleaved with the primary winding. For example, the primary winding is placed in between secondary windings (or vice versa). The winding structure of FIG. 6 makes it difficult to create such a structure. FIG. 7 illustrates a structure in which the primary winding is formed by two windings L101 and L102 which are in series.

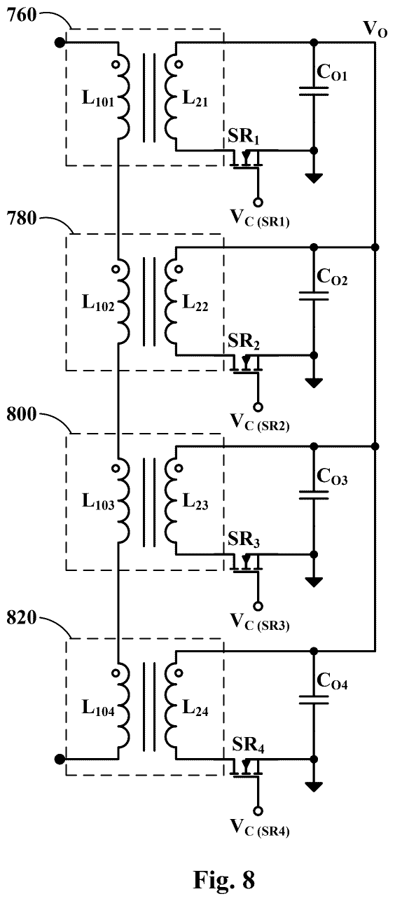

In the transformer depicted in FIG. 7, the primary winding L101 is very well coupled with L21, forming the structure 720, and the primary winding L102 is very well coupled to the secondary winding L22, forming a structure 740. The winding structure 720 and the winding structure 740 may share the main post in the magnetic core, for example, a U core wherein the structure 720 is placed on one the left leg and the structure 740 is placed on the right leg. FIG. 8 depicts four winding structures in which the primary winding and secondary windings are very well coupled, and placed on a post in a magnetic structure with multiple posts. FIG. 8 illustrates a well-coupled winding structure between primary and secondary, wherein each such structure is placed on each of the posts. FIG. 8 shows a magnetic structure with four posts. The secondary of each winding structure is connected to a synchronous rectifier. In the structure depicted in FIG. 8, the output current is shared among four independent paths wherein the coupling between the primary winding and the secondary winding on each winding structure placed on each posts of a multiport magnetic core.

The structure from FIG. 7 is suitable for the magnetic core. In conclusion, for higher output current applications and low leakage inductance multiple leg magnetic structures (two legs and more) are very suitable for the flyback topology, both for one switch flyback or two transistors flyback topology presented in this patent. Having a low leakage inductance helps considerably in the applications in which passive clamp solutions are used, as is the case of this description.

There are applications where leakage inductance cannot be reduced, such as higher power flyback of output power more than 100 W in which conventional magnetics are used. In such applications, the reverse recovery of the passive clamp diode may not be enough to process the leakage inductance energy. In FIG. 3B, both diodes, DC4 and DC3 have reverse recovery characteristics that allow full utilization of the leakage inductance. As previously presented, the presence of VB which is part of Energy Extraction Circuit (580) reduces the change injected in clamp capacitor CC1. As a result, the reverse charge which is extracted via DC3 and DC4 during the reverse recovery time is also reduced, which allows the full transfer of the reverse charge to the secondary via L2 and SR to the secondary.

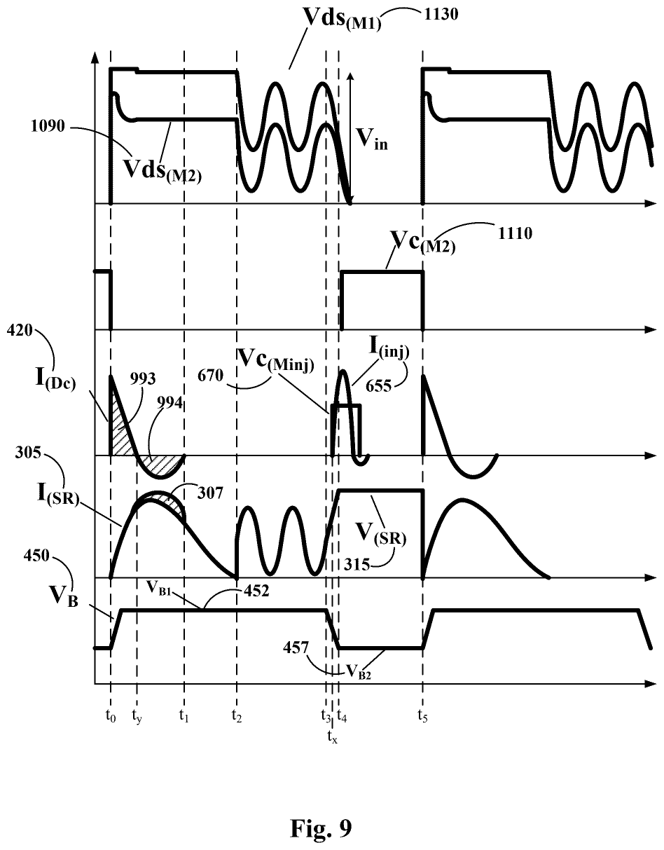

FIG. 9 presents waveforms associated with the two-transistor flyback topology utilizing the passive clamp. At to when the Vc(M2), (1110) becomes zero and turns off M1 (950) and M2 (910), and the leakage inductance current in the transformer, due to the leakage inductance in between L1 (920) and L2 (930), flows via DC3, (410), and DC4, (390), and further through diode (440) towards VB (450), increasing its amplitude from VB2 (457) to VB1, (452). The current transfers energy from the leakage inductance into the VB, (450) as depicted in FIG. 3A or into CB, (455) as depicted in FIG. 3B. This type of energy transfer occurs in between t0 to ty, depicted by the current (993). Due to the reverse recovery of DC3, (410), and DC4 (390) the charge injected in CC1 (420) is fully extracted in between ty and t1 by the current (994) based on the preservation of charge law. The reverse current (994) is transferred into the secondary via I(SR), 305 increasing its amplitude by the (307) amount.

The current through SR, (300), I(SR), (305), reaches zero at t2, after which the parasitic oscillations start developing across the primary and secondary winding between t2 to t3. The parasitic oscillations do occur across both switching devices, M1 and M2 and also across the SR in the secondary.

The current injection pulse is activated in at tx, in between t3 to t4. A pulse of current I(inj), (655) is injected into the primary winding discharging the parasitic capacitance reflected across M1 and M2 to zero, creating zero voltage switching conditions. The energy for the current injection is extracted from VB and the voltage on it, is decaying from VB1 (452) level at t3 to VB2 (457) level at t4.

The reverse characteristic of DC4 from FIG. 3B is similar to the reverse characteristics of DC3.

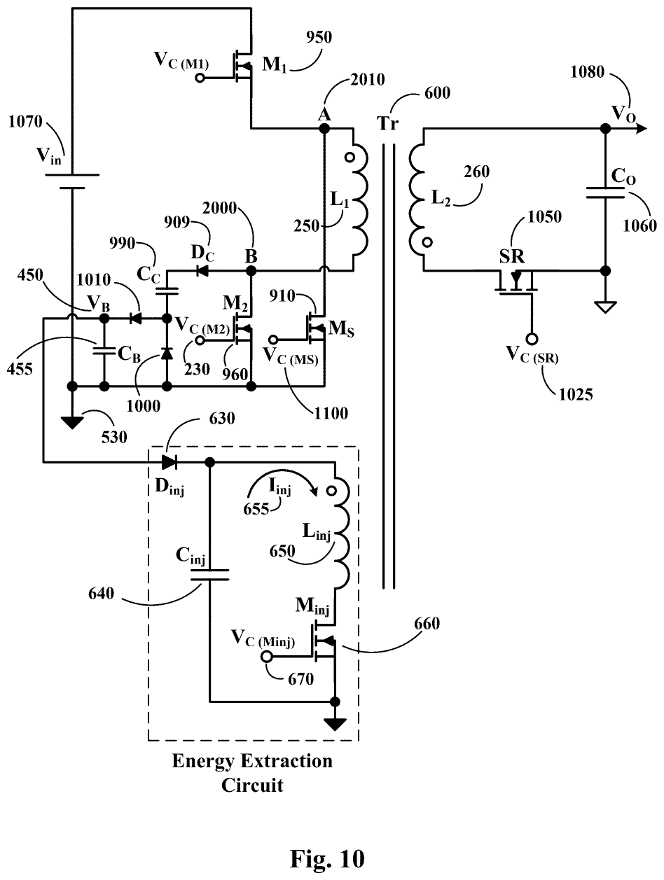

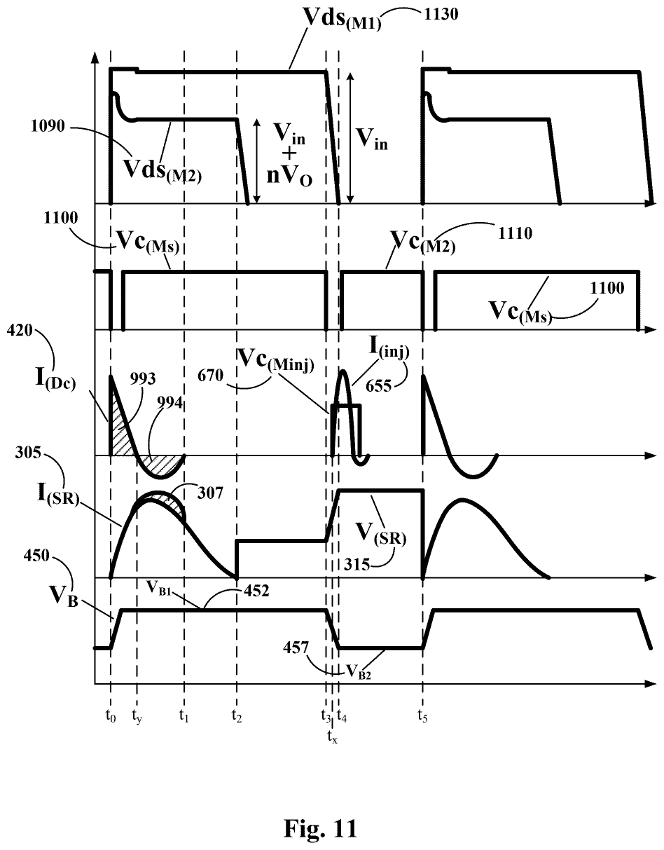

FIG. 10 presents a two-transistor flyback topology in which the DC4 (390) from FIG. 3B is replaced by a control switch Ms (910) controlled by a control signal Vc(MS) (1100). In one of the embodiments the control signal Vc(Ms) (1100) is complementary to the control signal for M2, which is Vc(M2), (230). That means that when M2 is on, Ms is off and vice versa and there is a small dead time in between. In other embodiments, the Vc (MS) is activated after a dead time after M2 is turned off and the duration of Vc(Ms) can be shorter than the complementary M2 signal. Vc (MS) can be, in some applications, shorter than the conduction time of SR, which occurs between t0 to t2 as shown in FIG. 11. In such mode of operation, parasitic oscillations which occur after I(SR) become zero, will appear. That mode of operation allows the M1 and M2 to turn on, on the valley as is done in FIG. 9. The duration of the Vc (MS) signal gives the designer significant flexibility in choosing the mode of operation. The operation of the converter is by using valley detection and turning on M1 and M2 on the valley of the parasitic oscillations. In addition, by using the control switch for MS to be complimentary of the control signal of M2, the converter is able to operate at constant frequency which does have benefits in respect of EMI reduction at the system level wherein the two-transistor flyback topology is used.

FIG. 11 presents waveforms of the circuit from FIG. 10. Those include the voltage across the switch M1, Vds(M1), (1130), the voltage across M2, Vds(M2), (1090), the control signal for MS, Vc(MS), (1100), the control signal for M2, Vc(M2), (230), the current through the clamp diode DC, (909), I(DC), (420), the control signal for the current injection switch, Vc(Minj), (670), the current injection, I(inj), (655), the current through the output synchronous rectifier, I(SR), (305), and the voltage across SR, V(SR), (315) and the voltage across CB, which is VB, (450).

At t0, both switchers, M1 and M2 turn off, and the current through the leakage inductance between L1, (250) and L2, (260) flows via the passive snubber DC, (909) and Cc, (990) towards the CB, (455).

Between t0 to ty, the current flowing through the passive snubber and through diode (1010) charges the CB (455), from VB2 (457), to VB1 (452). Between ty to t1, the current through the passive clamp flows in the opposite direction, (994), via diode (1000) extracting the same charge which was injected in CC during t0 to ty. The reverse current through I(DC), 994 reflects into the secondary increasing the current through SR as depicted by 307. Further from t1 to t3 the Ms, (910) switch is on, creating a short across L1 (250) and eliminates the parasitic oscillations presented in FIG. 9 between t2 to t3, wherein Ms, (910) is not present.

At t3 the shorting switch Ms is turned off. The negative magnetizing current which is energized by the energy in the parasitic capacitance in node B, (2000) of the circuit from FIG. 10 discharges the parasitic capacitance reflected across M1, to zero at t4. In some applications in which there is not enough energy in the negative magnetizing current, the discharge of the parasitic capacitance reflected across M1 is assisted by the current injection I(Inj), (655).

The presence of Ms (910) ensures that the positive and negative current through the passive snubber DC (909) and Cc, (990) flows towards node A without relying on the reverse recovery characteristics of DC4 (390) as in FIG. 3B. In addition to that, the switch MS, (910) eliminates the parasitic oscillations and gives more flexibility of the mode of operation without the need to turn on M1 and M2 on the valley of the parasitic oscillations. The Ms (910) allows operation at any frequency and also at constant frequency.

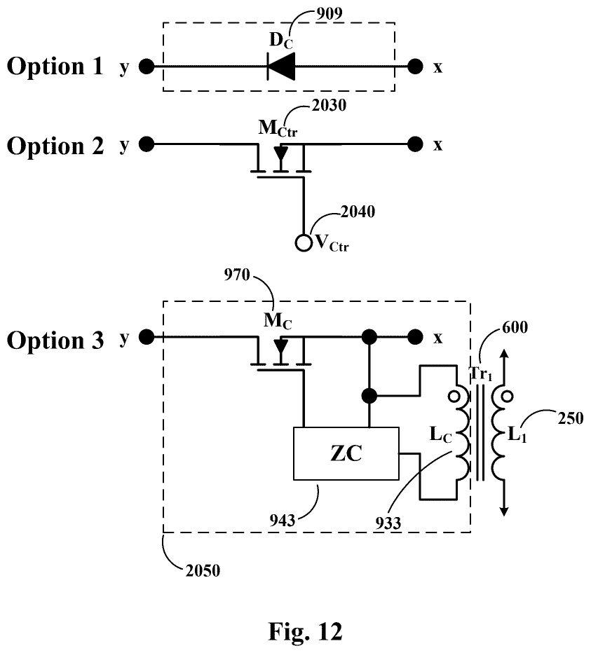

Another embodiment of this specification replaces the clamp diode DC (909) from FIG. 10 with a controlled switch which controls the forward and reverse flow of current through the diode (1010) and diode (1000). FIG. 12 presents several methods of implementing the clamp diode DC. (909).

In option 1 of FIG. 12, DC (909) is a rectifier with adequate reverse recovery characteristics. In Option 2, DC (909) is replaced by a mosfet Mctr, (2030), controlled by a control signal Vcrt (2040). In option 3, DC (909) is replaced by control mosfet, MC (970) which is controlled via a network ZC, (943) which is connected to an auxiliary winding LC, (933) on the main transformer 600.

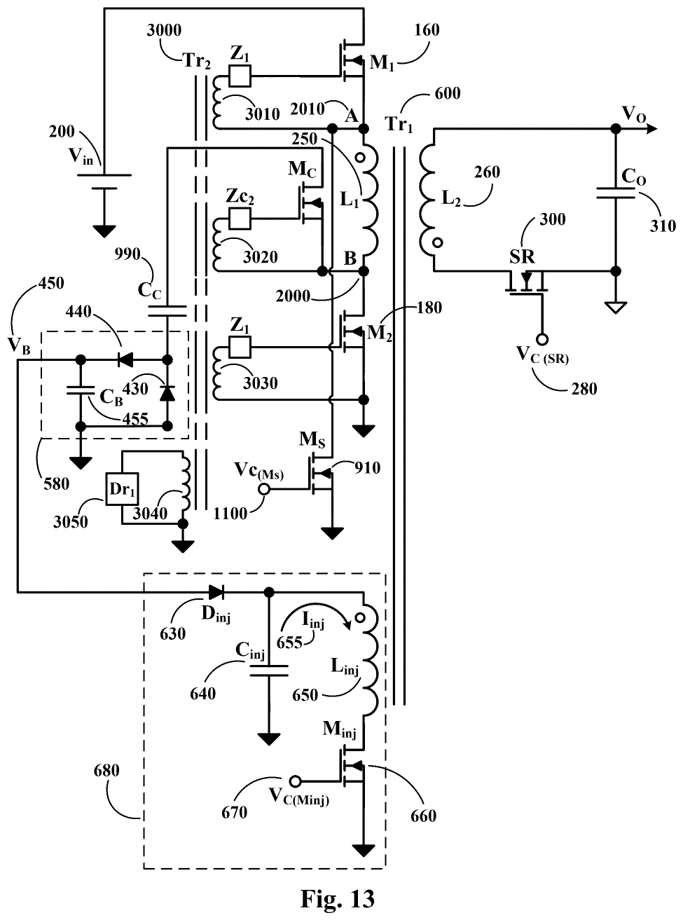

In the circuit presented in FIG. 11, in which the switch MS (910) is used, there are not parasitic oscillations across M1 and M2, unlike the operation mode of FIG. 9. The parasitic oscillations do apply if the shorting switch MS (910) is not used and the DC4 (390) with reverse recovery characteristics is used. Parasitic oscillations can also appear in the applications wherein MS (910) is turned off prior t2 when the current through SR reaches zero. When operation does create parasitic oscillations, the solution provided in Option 3 does not function properly. In such applications, the circuit presented in FIG. 13 is preferably used. In FIG. 13, the DC (909) is replaced by the mosfets MC (970). The MC (970) is driven by a winding (3020) of the drive transformer Tr2 (3000) which also drive one or both switching devices, M1 (160) and M2 (180). The drive transformer Tr2 (3000) may be used in most applications to drive M1 and even M2. The additional winding (3020) does not add a significant cost. The solution presented in FIG. 13 eliminates problems which may appear in the self-driven clamp suggested in Option 3, when there are parasitic oscillations.

In the circuit implemented in FIG. 13, there is no reliance on the reverse recovery characteristics of diodes as is the circuit presented in FIG. 3A and FIG. 3B. That makes the circuit in FIG. 13 preferable for a larger range of applications such as larger leakage inductance magnetics, and much higher power applications. At the same time, the use of the shorting switch MS (910) optimizes the operation of the two-transistor flyback topology, converting this topology in the ideal two transistor flyback topology. In this topology, all the switching devices turn on at zero voltage, eliminating switching losses. In the secondary, the SR turns off at zero current and there are not voltage spikes or ringing across any of the switching elements in this topology. These conditions are maintained in all the operating conditions. There is no need for snubbers in this topology.

FIG. 13 presents a two-transistor flyback converter which uses an active switch Mc for the active clamp. The active clamp switch Mc is driven by the drive transformer Tr2, (3000).

Initially, M1 and M2 conduct and accumulate energy in the transformer Tr, (600). After the energy is stored in Tr, (600), M1 and M2 turn off. The current in the primary of the transformer energized by the energy in the leakage inductance will flow initially through the body diode of Mc and further through the clamp capacitor Cc (990) into the energy extraction circuit (580), via the diode (440) into the capacitor CB (455) increasing the voltage level on CB (455) from VB2 level (457) to VB1 level (452) as depicted in FIG. 11. This is done in between t0 and t1. The current injected in CB (455) in between t0 and ty is (993). The controlled clamp switch is kept on from t0 to t1 in such a way that the charge injected in the clamp capacitor Cc(990) is fully extracted in between ty and t1 in compliance with preservation of charge law. The current flow via Mc in reverse (994) which ensure that the charge injected in the clamp capacitor Cc (990) during t0 to ty is equal to the reverse current (994) which represents the charge extracted from Cc (990). The current flow in reverse via the Mc and Cc (990) is reflected into the secondary via the L1 (260) and SR (300), represented by (307), adding to the energy transferred via the SR into the secondary in the flyback mode.

For a preferred operation the drive signal which is applied on the winding (3020) of the drive transformer has a duration equal or larger than the duration from t0 to t1 until the negative current (994) from FIG. 11 becomes zero. The active clamp formed by the controlled switch Mc together with the clamp capacitor Cc (990) operates as an ideal clamp wherein the full charge injected in Cc (990) is fully extracted during the time Mc is on. As a result, there are no spikes or ringing on the Mc nor on CC (990) and no ringing across the primary winding.

This mode of operation is optimized and makes the two-transistor flyback topology an “ideal two transistor flyback topology”, wherein all the switching elements turn on at zero voltage, eliminating switching losses, and wherein the energy in the leakage inductance is partially transferred to the energy extraction circuit (580) to be used for the current injection circuit (680) and create zero voltage switching conditions for M1 and M2 and the remaining leakage inductance energy is transferred to the secondary s the load optimally during the time interval ty to t1. In the implementation depicted in FIG. 13, using controlled active switch Mc, there is no dependency of the reverse recovery characteristics associated with the passive clamp.

The circuit depicted in FIG. 13 allows operation of the two-transistor flyback topology in a very large range of applications in respect of input and output voltage and power level.

A preferred embodiment is fully and clearly described above so as to enable one having skill in the art to understand, make, and use the same. Those skilled in the art will recognize that modifications may be made to the description above without departing from the spirit of the specification, and that some embodiments include only those elements and features described, or a subset thereof. To the extent that modifications do not depart from the spirit of the specification, they are intended to be included within the scope thereof.

What is claimed is:

1. A circuit having primary and secondary sides, the circuit comprising:
a flyback power converter including an input voltage source and a transformer having primary and secondary windings on the primary and secondary sides, respectively;
two main switchers in series with the primary winding on the primary side; and
said two main switchers are controlled by two control signals;
the first main switch connected in between said input voltage source and the first terminal of said primary winding;
the second main switch connected to the second terminal of said primary winding;
parasitic capacitors across each of said two main switchers;
a passive clamp circuit across one of said primary switchers, the passive clamp circuit comprising a clamp diode, a clamp capacitor;
an auxiliary circuit comprising first and second rectifiers in series with each other and in series with an electronic component configured to store electromagnetic energy, the electronic component having first and second terminals;
wherein an anode of the first rectifier is connected to the passive clamp circuit, and a cathode of the first rectifier is connected to the second terminal of electronic component;
wherein a cathode of the second rectifier is connected to the anode of the first rectifier, and an anode of the second rectifier is connected to the first terminal of the electronic components.

2. The circuit of claim 1, wherein the auxiliary circuit is configured to reduce the RMS current through the clamp capacitor from a first current value to a second current value which is at least twenty percentage lower than the first current value, and to reduce a charge through the clamp capacitor from a first charge value to a second charge value which is at least twenty percent lower than the first charge value.

3. The circuit of claim 2, wherein the clamp diode is formed by several diodes in parallel.

4. The circuit of claim 2, wherein the electronic component includes a voltage source, the second terminal is a positive terminal of the voltage source and the first terminal is a negative terminal of the voltage source.

5. The circuit of claim 2, wherein the clamp diode is formed by a control switch.

6. The circuit of claim 5, wherein the control switch is implemented by a controlled mosfet wherein its body diode conducts current in a same direction as said clamp diode.

7. The circuit of claim 5, wherein the control switch is controlled by a winding which is incorporated in said transformer.

8. The circuit of claim 1, further comprising a driving transformer which controls at least one of said main switchers.

9. The circuit of claim 8, wherein the control switch is controlled by one of the windings of said driving transformer.

10. A method of operating a circuit having primary and secondary sides, the method comprising:
providing a flyback power converter including an input voltage source and a transformer having primary and secondary windings on the primary and secondary sides, respectively;
providing two main switchers in series with the primary winding on the primary side; and
said two main switchers are controlled by two control signals;
a passive clamp circuit across one of said primary switchers, the passive clamp circuit comprising a clamp diode, a clamp capacitor;
an auxiliary circuit comprising first and second rectifiers in series with each other and in series with an electronic component configured to store electromagnetic energy, the electronic component having first and second terminals;
wherein an anode of the first rectifier is connected to the passive clamp circuit, and a cathode of the first rectifier is connected is connected to the second terminal of electronic component;
wherein a cathode of the second rectifier is connected to the anode of the first rectifier, and an anode of the second rectifier is connected to the first terminal of the electronic components; and
directing a current, flowing through a leakage inductance reflected in the primary side of the transformer, to flow through the clamp capacitor and through the first rectifier towards the auxiliary energy storage, so as to change the first charge value, thereby imparting a second charge value to flow through the second rectifier during a reverse recovery time of the clamp diode, so as to balance the electrical charger in the clamp capacitor.

11. A method of operating a circuit having primary and secondary sides, the method comprising:
providing a flyback power converter including an input voltage source and a transformer having primary and secondary windings on the primary and secondary sides, respectively;
providing two main switchers in series with the primary winding on the primary side; and
said two main switchers are controlled by two control signals;
parasitic capacitors across each of said two main switchers;
an active clamp circuit across one of said primary switchers, the active clamp circuit comprising a controlled switch clamp, a clamp capacitor;
an auxiliary circuit comprising first and second rectifiers in series with each other and in series with an electronic component configured to store electromagnetic energy, the electronic component having first and second terminals;
wherein an anode of the first rectifier is connected to the active clamp circuit, and a cathode of the first rectifier is connected is connected to the second terminal of electronic component;
wherein a cathode of the second rectifier is connected to the anode of the first rectifier, and an anode of the second rectifier is connected to the first terminal of the electronic components;
directing a current, flowing through a leakage inductance reflected in the primary side of the transformer, to flow through said controlled switch clamp and through the clamp capacitor and through the first rectifier towards the auxiliary energy storage, so as to change the first charge value, thereby imparting a second charge value to flow through the second rectifier during the time said controlled switch clamp is conducting, so as to balance the electrical charger in the clamp capacitor.

12. The circuit of claim 11 further comprising:
a current injection circuit including a current injection winding in the said transformer having first and second terminals;
a current injection switch connected to the first terminal of the current injection winding;
a current injection diode, with a cathode connected to the second terminal of the current injection winding and an anode connected to the electronic component configured to store electromagnetic energy;
an energy source to collect energy of a leakage inductance of the transformer via a passive clamp and first rectifier; and
the current injection winding configured to inject the energy as a pulse current into the transformer via the current injection winding so as to discharge parasitic capacitors across each of said two main switchers to create zero voltage switching condition for said two main switchers.

13. The circuit of claim 11 further comprising:
a current injection circuit including a current injection winding in the said transformer having first and second terminals;
a current injection switch connected to the first terminal of the current injection winding;
a current injection diode, with a cathode connected to the second terminal of the current injection winding and an anode connected to the electronic component configured to store electromagnetic energy;
an energy source to collect energy of a leakage inductance of the transformer via a control switch clamp and first rectifier; and
the current injection winding configured to inject the energy as a pulse current into the transformer via the current injection winding so as to discharge parasitic capacitors across each of said two main switchers to create zero voltage switching condition for said two main switchers.

14. The circuit of claim 13 further comprising a third switch connected in between the first terminal of primary winding and the terminal of said second main switch terminal not connected to said primary winding.

15. The circuit of claim 14, wherein the third switch is controlled by a control signal which is complementary to the control signal which controls the second main switch, such that the third switch is on while the second main switch is off.

16. The circuit of claim 14, wherein the third switch is controlled by a control signal which is on for a given period of time after a small dead time after the control signal for second main switch is off.

17. The circuit of claim 16, wherein the third switch control signal is on for a period of time to allow the repetition frequency to be constant.
